(19) United States
(12) Patent Application Publication
(10) Pub. No.: US 2024/0264015 A1
(43) Pub. Date: Aug. 8, 2024

(54) STRAIN DETECTION DEVICE

(71) Applicant: Japan Display Inc., Tokyo (JP)

(72) Inventors: Fumihoru NAKANO, Tokyo (JP); Toshinori UEHARA, Tokyo (JP)

(21) Appl. No.: 18/425,674

(22) Filed: Jan. 29, 2024

(30) Foreign Application Priority Data
Jan. 30, 2023 (JP) 2023-011849

(51) Int. Cl. G01L 1/22

(52) U.S. Cl. CPC G01L 1/225

(57) ABSTRACT

According to one embodiment, a strain detection device includes a first sensor sheet and a second sensor sheet opposed to the first sensor sheet with a base sandwiched therebetween, and a controller which drives the first sensor sheet and the second sensor sheet. Each of the first sensor sheet and the second sensor sheet includes strain gauges arranged in a row, power supply lines and first signal lines connected to first ends of the strain gauges, and ground lines and second signal lines connected to second ends of the strain gauges. Each of the ground lines of the first sensor sheet is connected to corresponding one of the power supply lines of the second sensor sheet.

### CROSS-REFERENCE TO RELATED APPLICATIONS

This application is based upon and claims the benefit of priority from Japanese Patent Application No. 2023-011849, filed Jan. 30, 2023, the entire contents of which are incorporated herein by reference.

### FIELD

Embodiments described herein relate generally to a strain detection device.

### BACKGROUND

Flexible film-shaped or sheet-shaped strain gauge sensors are known as an example of strain detection devices. The strain gauge sensor includes strain gauges provided side by side on a surface of a strip-shaped flexible sheet substrate and a plurality of signal lines for energizing these strain gauges. In addition, in a strain gauges disclosed in Patent Literature 2, a plurality of strain gauges are provided on front and rear sides of a sheet. The strain gauges on the front side are arranged to be opposite to the strain gauges on the rear side, respectively. By wrapping the strain gauge sensor around a curved subject and detecting the resistance change of each strain gauge, a curved shape of the subject can be detected.

In the strain gauge sensor, it is difficult to align the wiring resistance of the strain gauges on the front and rear sides of the sheet due to differences in temperature conditions between the front and rear sides of the sheet, which may adversely affect the accuracy of strain detection.

### BRIEF DESCRIPTION OF THE DRAWINGS

FIG. 1 is a perspective view showing a strain gauge sensor device according to an embodiment.

FIG. 2 is a longitudinal cross-sectional view showing the strain gauge sensor device.

FIG. 3 is a developed view schematically showing gauge patterns and wiring patterns of the first and second sensor sheets of the strain gauge sensor device.

FIG. 4 is a block diagram showing a controller of the strain gauge sensor device.

FIG. 5 is a circuit diagram showing a differential detection circuit in an analog front end of the controller.

FIG. 6 is a side view schematically showing a state in which the strain gauge sensor device is installed on a surface of a subject.

FIG. 7 is a timing chart showing various signals of the strain gauge sensor device at the detection.

FIG. 8 is a developed view showing the strain gauge sensor device, illustrating a scanning operation at the detection.

FIG. 9 is a developed view showing the strain gauge sensor device, illustrating a scanning operation at the detection.

FIG. 10 is a view schematically showing a part of the strain gauge sensor device in a state of being installed on a circumferential surface of a subject.

FIG. 11 is an equivalent circuit diagram showing the first and second sensor sheets.

FIG. 12 is a cross-sectional view showing the strain gauge sensor device according a modified example.

### DETAILED DESCRIPTION

Various embodiments will be described hereinafter with reference to the accompanying drawings. In general, according to one embodiment, a strain detection device comprises a flexible base having a first main surface and a second main surface opposed to the first main surface; a first sensor sheet provided on a side of the first main surface; a second sensor sheet provided on a side of the second main surface and opposed to the first sensor sheet with the base sandwiched therebetween; and a controller configured to drive the first sensor sheet and the second sensor sheet.

Each of the first sensor sheet and the second sensor sheet comprises a plurality of strain gauges including first ends and second ends located on a side opposite to the first ends and arranged in a row at intervals; and a plurality of power supply lines, a plurality of ground lines, a plurality of first signal lines, and a plurality of second signal lines, which include portions extending along the row of the plurality of strain gauges. Each of the plurality of power supply lines is connected to corresponding one of the first ends of the plurality of strain gauges, each of the plurality of first signal lines is connected to corresponding one of the first ends of the plurality of strain gauges, each of the plurality of ground lines is connected to corresponding one of the second ends of the plurality of strain gauges, each of the plurality of second signal lines is connected to corresponding one of the second ends of the plurality of strain gauges, each of the plurality of strain gauges of the first sensor sheet is arranged to be opposed to corresponding one of the plurality of strain gauges of the second sensor sheet with the base sandwiched therebetween, and each of the plurality of ground lines of the first sensor sheet is connected to corresponding one of the plurality of power supply lines of the second sensor sheet.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes and the like, of the respective parts are illustrated schematically in the drawings, rather than as an accurate representation of what is implemented, but such schematic illustration is merely exemplary, and in no way restricts the interpretation of the invention. In addition, in the specification and drawings, the same elements as those described in connection with preceding drawings are denoted by like reference numbers, and detailed description thereof is omitted unless necessary.

### EMBODIMENTS

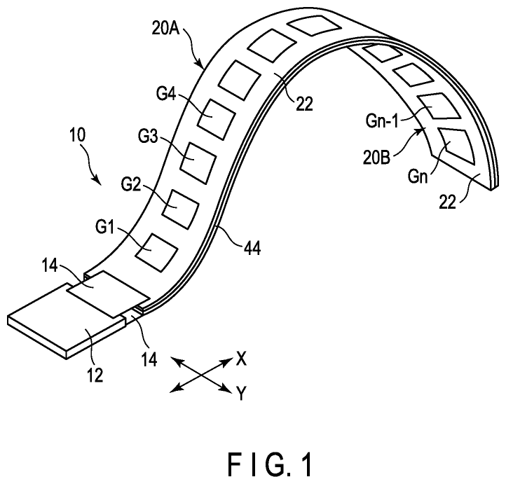

A strain gauge sensor device according to an embodiment will be described in detail as an example of a strain detection device. FIG. 1 is a perspective view showing a strain gauge sensor device according to an embodiment.

As shown in the drawing, a strain gauge sensor device 10 constitutes a double-sided strain gauge sensor. The strain gauge sensor device 10 comprises an elongated strip-shaped flexible base substrate 44 that functions as a base, a first sensor sheet 20A attached to a first main surface (front side) of the base substrate 44, a second sensor sheet 20B attached to a second main surface (rear side) of the base substrate 44, a pair of flexible printed circuits (FPC) 14, and a relay board (drive circuit board) 12 connected to the first sensor sheet 20A and the second sensor sheet 20B via the pair of flexible printed circuit 14. In one example, the base substrate 44 is formed of a resin such as polyethylene terephthalate (PET) or polyimide having a thickness of approximately 0.3 to 0.5 mm.

Each of the first sensor sheet 20A and the second sensor sheet 20B includes an elongated strip-shaped flexible sheet base 22 and a conductor pattern provided on one side of the sheet base 22. The conductor pattern includes a plurality of strain gauges G1 to Gn. The plurality of strain gauges G1 to Gn are arranged in the longitudinal direction X at predetermined intervals from one end to the other end of the longitudinal direction X of the sheet base 22.

In the drawing, a longitudinal direction X and a width direction Y of the sensor sheet are two directions orthogonal to each other. These directions may intersect at an angle other than ninety degrees.

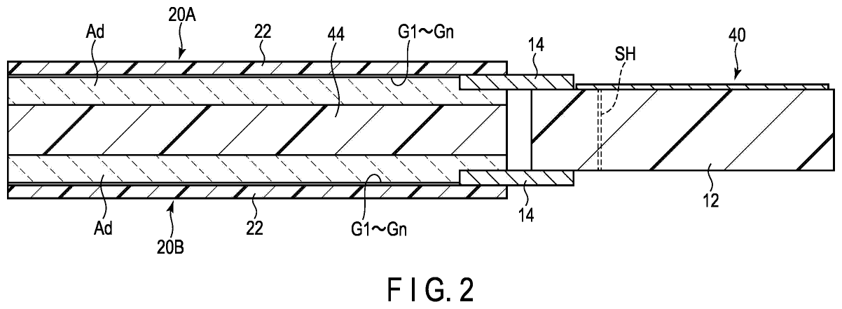

FIG. 2 is a longitudinal cross-sectional view showing the strain gauge sensor device 10.

As shown in FIG. 2, the base substrate 44 has a front surface and a rear surface opposite to the front surface. In one example, in the first sensor sheet 20A, the side having conductor patterns (G1 to Gn) is attached to the front surface of the base substrate 44 by an adhesive layer Ad such as a transparent adhesive sheet (OCA). In the second sensor sheet 20B, the side having conductor patterns (G1 to Gn) is attached to the rear surface of the base substrate 44 by an adhesive layer Ad.

The relay substrate 12 includes a drive circuit 40 and a plurality of wirings provided on one surface side and a plurality of wirings on the other surface side (not shown). The conductor pattern of the first sensor sheet 20A is connected to the wirings provided on the upper surface side of the relay substrate 12 via the FPC 14. Similarly, the conductor pattern of the second sensor sheet 20B is connected to the wirings provided on the lower surface side of the relay substrate 12 via the FPC 14.

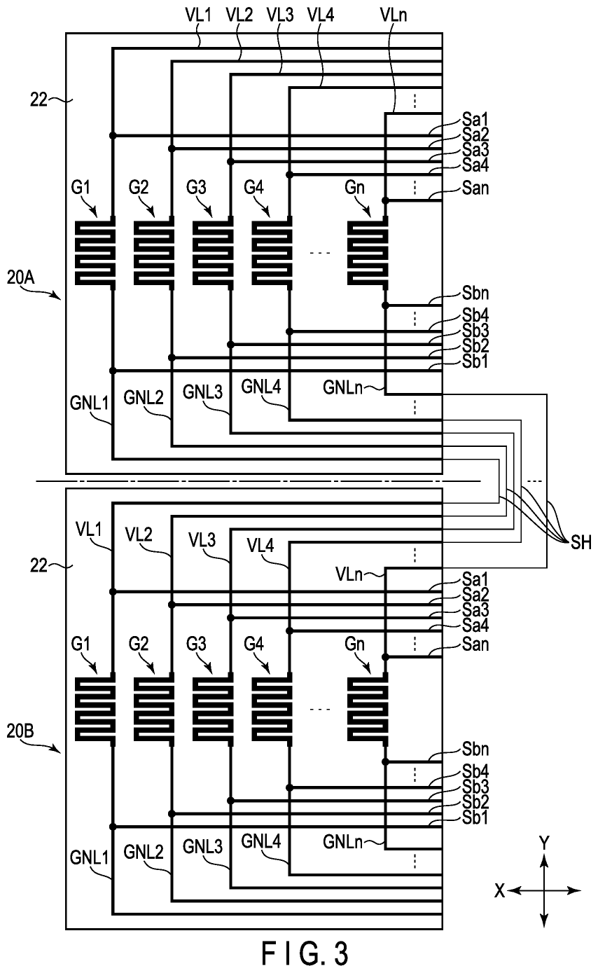

FIG. 3 is a plan view schematically showing the strain gauges and wiring patterns of the first sensor sheet 20A and the second sensor sheet 20B in a state in which the first sensor sheet 20A and the second sensor sheet 20B are developed. As shown in the drawing, according to the embodiment, the first sensor sheet 20A and the second sensor sheet 20B are configured to have the same shapes, dimensions, and conductor patterns. More specifically, each of the first sensor sheet 20A and the second sensor sheet 20B includes a flexible strip-shaped sheet base 22 and a conductor pattern provided on one surface side of the sheet base 22. The conductor pattern includes a plurality of strain gauges G1 to Gn. The plurality of strain gauges G1 to Gn are arranged in a row at intervals in the longitudinal direction X from one end (distal end) to the other end (proximal end) of the sheet base 22. Each of the strain gauges G1 to Gn extends in a bellows shape in the width direction Y and has one end (often referred to as a first end) and the other end (often referred to as a second end) in the width direction Y. Each of the strain gauges G1 to Gn produces a resistance change in response to the strain.

The conductor pattern includes a plurality of power supply lines VL1 to VLn, a plurality of ground lines GNL1 to GNLn, a plurality of first signal lines Sa1 to San, and a plurality of second signal lines Sb1 to Sbn, each extending in the longitudinal direction X along a row of the strain gauges G1 to Gn.

The power supply lines VL1 to VLn are located on one end side of the strain gauges G1 to Gn. The power supply lines VL1 to VLn each have one end connected to one end (first end) of the strain gauges G1 to Gn and the other end located on the proximal end side of the sheet base material 22, and extend substantially parallel to each other.

The first signal lines Sa1 to San are located between one-side ends of the strain gauges G1 to Gn and the power supply lines VL1 to VLn. The first signal lines Sa1 to San have one-side ends connected to the one-side ends (first ends) of the strain gauges G1 to Gn, respectively, and have the other ends located on the proximal end side of the sheet base 22, and extend substantially parallel to each other.

The ground lines GNL1 to GNLn are located on the other end sides of the strain gauges G1 to Gn. The ground lines GNL1 to GNLn each have one end connected to the other end (second end) of the strain gauges G1 to Gn and the other end located on the proximal end side of the sheet base 22, and extend substantially parallel to each other.

The second signal lines Sb1 to Sbn are located between the other ends of the strain gauges G1 to Gn and the ground lines GNL1 to GNLn. The second signal lines Sb1 to Sbn have one-side ends connected to the other ends (second ends) of the strain gauges G1 to Gn, respectively, and have the other ends located on the proximal end side of the sheet base 22, and extend substantially parallel to each other.

The first sensor sheet 20A and the second sensor sheet 20B configured as described above are attached to the front and rear surfaces of the base substrate 44 and face each other across the base substrate 44. In other words, the strain gauges G1 to Gn of the first sensor sheet 20A are opposed to the strain gauges G1 to Gn of the second sensor sheet 20B, respectively, across the base substrate 44. Each of the strain gauges G1 to Gn of the first sensor sheet and each of the strain gauges G1 to Gn of the second sensor sheet desirably overlap with each other, at least partially, in plan view of viewing from a direction perpendicular to the surface of the base substrate 44. Alternatively, the strain gauges G1 to Gn of each of these sensor sheets 20A and 20B desirably overlap without being at least displaced in the width direction Y while allowing displacement in the longitudinal direction X. Alternatively, the strain gauges G1 to Gn of each of these sensor sheets 20A and 20B desirably overlap without being displaced in the longitudinal direction X or the width direction Y.

The ground lines GNL1 to GNLn of the first sensor sheet 20A extend to the upper surface of the relay substrate 12 through the FPC 14. The power lines VL1 to VLn of the second sensor sheet 20B extend to an upper part of the rear surface of the relay substrate 12 through the FPC 14. In the embodiment, the ground lines GNL1 to GNLn of the first sensor sheet 20A are electrically connected to the power lines VL1 to VLn of the second sensor sheet 20B, respectively, at the position of the relay board 12, i.e., short-circuited. As shown in FIG. 2, the ground lines GNL1 to GNLn and the power supply lines VL1 to VLn are connected by plated through holes SH that serve as connection lines formed on the relay board 12. Incidentally, the connection lines are not limited to the plated through holes SH, but may also be wiring patterns on the relay board 12. In addition, the FPC 14 on the second sensor sheet 20B side is also connected to the upper side of the relay board 12, such that a configuration to connect the ground lines GNL1 to GNLn of the first sensor sheet 20A to the power lines VL1 to VLn of the second sensor sheet 20B, respectively, via the wirings on the relay substrate 12 instead of the plated through holes can also be adopted. Furthermore, a configuration to connect the FPC 14 on the first sensor sheet 20A side and the FPC 14 on the second sensor sheet 20B side to the drive circuit 40 provided on the upper surface side of the relay board 12 and to connect the ground lines GNL1 to GNLn of the first sensor sheet 20A to the power supply lines VL1 to VLn of the second sensor sheet 20B, respectively, in the drive circuit 40 can also be adopted.

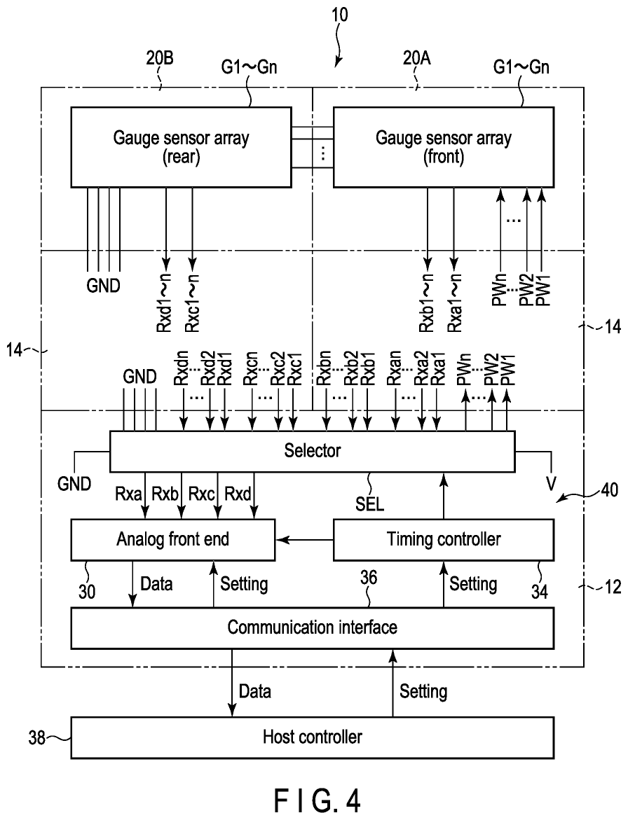

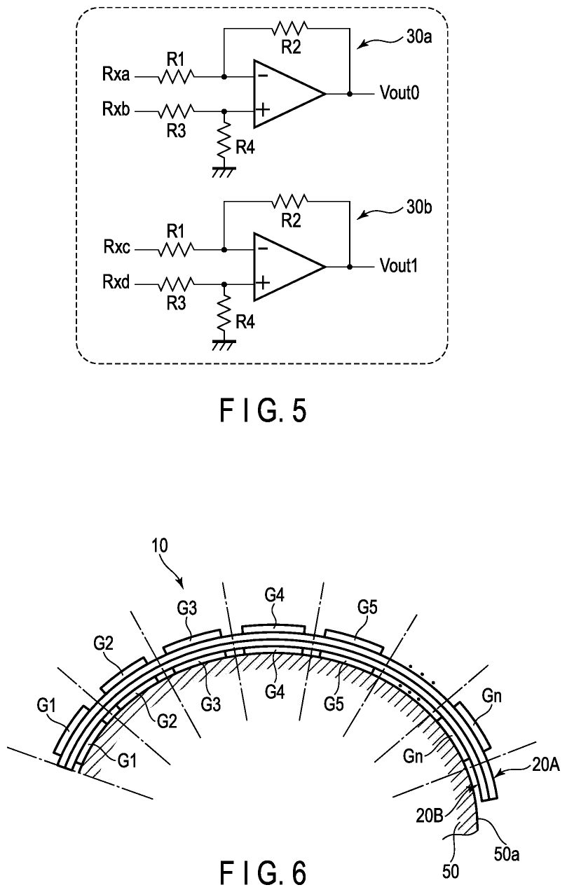

Next, the drive circuit (controller) that drives the first sensor sheet 20A and the second sensor sheet 20B configured as described above will be described. FIG. 4 is a block diagram schematically showing the drive circuit of the strain gauge sensor device 10, and FIG. 5 is a circuit diagram showing the differential detection circuit in the analog front end.

As shown in FIG. 4, the drive circuit 40 on the relay board (control circuit board) 12 includes a selector SEL, an analog front end (AFE: signal conditioning circuit) 30, a timing controller 34, a communication interface 36, and the like.

The communication interface 36 is connected to the external host controller 38 in a wireless or wired manner and receives drive signals (setting) from the host controller 38 and transmits detection data (Data) to the host controller 38.

The timing controller 34 outputs drive signals to a selector SEL and an analog front end 30 in response to the drive signals (setting).

The selector SEL is composed of a plurality of shift registers, multiplexers, and the like. The selector SEL sequentially connects the power supply lines VL1 to VLn of the first sensor sheet 20A to the power supply and sequentially applies voltages to the strain gauges G1 to Gn, in response to the drive signals from the timing controller 34. Synchronously with this, the selector SEL1 sequentially reads detection signals (voltage values) RXa1 to RXan and RXb1 to RXbn at one-end sides and the other end sides of the strain gauges G1 to Gn via the first signal lines Sa1 to San and the second signal lines Sb1 to Sbn. Furthermore, the selector SEL sequentially reads detection signals (voltage values) RXc1 to RXcn and RXd1 to RXdn of the one-end sides and the other end sides of the strain gauges G1 to Gn via the first signal lines Sa1 to San and the second signal lines Sb1 to Sbn of the second sensor sheet 20B, synchronously with the above reading.

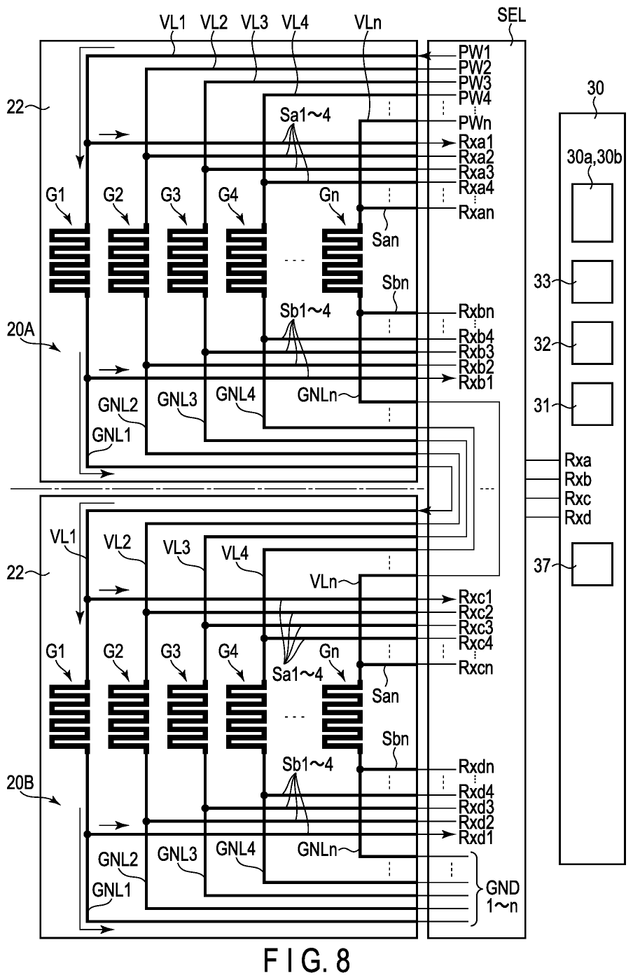

The analog front end 30 includes a read circuit 31, difference detection circuits 30a and 30b, an AD converter 32, a digital filter 33, a memory 37, and the like (see FIG. 8). As shown in FIG. 5, according to the embodiment, the analog front end 30 includes a difference detection circuit (subtraction circuit) 30a that processes the detection signals of the first sensor sheet 20A and a difference detection circuit (subtraction circuit) 30b that processes the detection signals of the second sensor sheet 20B. The analog front end 30 performs signal adjustment (amplification, AD conversion, and filtering) of the detection signals RXa and RXb and the detection signals RXc and RXd of the strain gauges G1 to Gn sent from the selector SEL, and outputs the signals to the communication interface 36, in response to the drive signal. At this time, since a voltage drop value of each strain gauge G is required to calculate the radius of curvature, differences between the detected values Rxa and Rxb of the strain gauges G1 to Gn and differences between the detected values Rxc and Rxd of the strain gauges G1 to Gn, are taken by the difference detection circuit 30a and 30b and output as signals.

The host controller 38 reads the output signals (data) sent from the communication interface 36 and performs arithmetic operations such as data forming and surface calculation to calculate the strain, curvature form, and the like of the subject detected by the first sensor sheet 20A and the second sensor sheet 20B.

Next, a detection operation mode of the strain gauge sensor system 10 will be described.

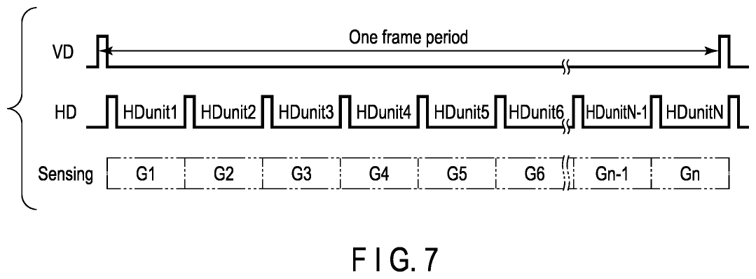

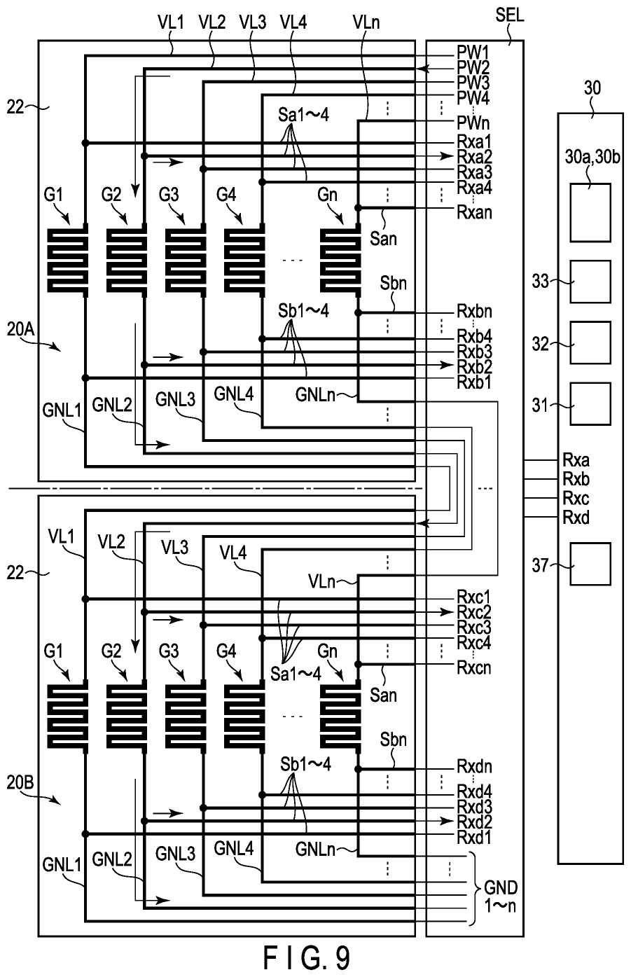

FIG. 6 is a view schematically showing a state in which the first and second sensor sheets are installed on the surface of the subject, FIG. 7 is a timing chart showing the signal output when operating in the detection operation mode, and FIG. 8 and FIG. 9 are plan views schematically showing a scanning operation of the strain gauge sensor device.

In one example, as shown in FIG. 6, the strain gauge sensor device 10 is installed to be wrapped around a circumferential surface 50a of a subject 50 to detect the curved form of the circumferential surface 50a. In this case, the strain gauge sensor device 10 is installed in a state in which the second sensor sheet 20B side is in contact with the circumferential surface 50a.

In the detection operation mode, the strain gauges G1 to Gn are sequentially driven by scanning and driving the power supply lines and the signal lines, and the detected values of the strain gauges G1 to Gn are read sequentially. More specifically, as shown in FIG. 7, the timing controller 34 inputs a start signal VD and a clock signal HD synchronized with the start signal VD to the selector SEL in response to an instruction from the host controller 38, and sequentially drives (setting) the strain gauges G1 to Gn of the first sensor sheet 20A and the second sensor sheet 20B in one frame period, at the detection.

As shown in FIG. 8, the selector SEL drives the power supply line VL1 of the first sensor sheet 20A, i.e., applies the power supply voltage to the power supply line VL1 and applies a desired voltage PW1 to the strain gauge G1. As a result, a current I is passed through the strain gauge G1 for a certain period of time. At the same time, the selector SEL acquires the detection signal (voltage value) RXa1 at one end of the strain gauge G1 and the detection signal (voltage value) RXb1 at the other end of the strain gauge G1 via the first signal line Sa1 and the second signal line Sb1.

The ground line GNL1 of the first sensor sheet 20A is connected to the power supply line VL1 of the second sensor sheet 20B. More specifically, the strain gauge G1 of the first sensor sheet 20A and the strain gauge G1 of the second sensor sheet 20B are connected in series via the ground line GNL1 of the first sensor sheet 20A, the connection line (plated through hole), and the power supply line VL1 of the second sensor sheet 20B. For this reason, when the strain gauge G1 of the first sensor sheet 20A is driven, the strain gauge G1 of the second sensor sheet 20B is driven synchronously and the current I is also passed through the strain gauge G1. At the same time, the selector SEL acquires the detection signal (voltage value) RXc1 at one end of the strain gauge G1 and the detection signal (voltage value) RXd1 at the other end of the strain gauge G1 via the first signal line Sa1 and the second signal line Sb1 of the second sensor sheet 20B.

The acquired detection signals RXa1, RXb1, RXc1, and RXd1 are sent to the analog front end 30, where the signals are adjusted and differentially detected and then stored in the memory 37.

As shown in FIG. 9, the selector SEL then drives the power supply line VL2 of the first sensor sheet 20A, i.e., applies the power supply voltage to the power supply line VL2 and applies a desired voltage PW2 to each of the strain gauge G2 of the first sensor sheet 20A and the strain gauge G2 of the second sensor sheet 20B. As a result, the current I is passed through the two opposed strain gauges G2 for a certain period of time. At the same time, the selector SEL acquires the detection signal RXa2 at one end of the strain gauge G2 and the detection signal RXb2 at the other end of the strain gauge G2 via the first signal line Sa2 and the second signal line Sb2 of the first sensor sheet 20A. At the same time, the selector SEL acquires the detection signal RXc2 at one end of the strain gauge G2 and the detection signal RXd2 at the other end of the strain gauge G2 via the first signal line Sa2 and the second signal line Sb2 of the second sensor sheet 20B.

The acquired detection signals RXa2, RXb2, RXc2, and RXd2 are sent to the analog front end 30, where the signals are adjusted and differentially detected and then stored in the memory 37.

After that, the selector SEL sequentially drives the strain gauges G3 to Gn of the first sensor sheet 20A and the strain gauges G3 to Gn of the second sensor sheet 20B, and sequentially acquires detection signals RXa3 to RXan, RXb3 to RXbn, RXc3 to RXcn and RXd3 to RXdn of the strain gauges G3 to Gn. The acquired detection signals are sequentially sent to the analog front end 30, adjusted and differentially detected, and then stored in the memory 37.

As described above, the analog front end 30 sequentially reads the sent detection signals RXa1 to RXan and RXb1 to RXbn, and the detection signals RXc1 to RXcn and RXd1 to RXdn by the read circuit 31, converts the signals into voltage signals, and further converts the voltage signals into digital data (Data) by the AD converter 32 and the digital filter 33. Furthermore, the analog front end 30 detects the differences between the detection signals RXa1 to RXan and RXb1 to RXbn and the differences between the detection signals RXc1 to RXcn and RXd1 to RXdn, by the difference detection circuits 30a and 30b. The detected difference data are sequentially stored in memory 37. When completing scanning for one frame period, the analog front end 30 reads the difference data for one frame from the memory 37 and outputs the difference data to the host controller 38. The host controller 38 calculates the curved form of the circumferential surface 50a of the subject 50, based on the sent data.

The calculation of the curved form or, in one example, the radius of curvature, will be described below.

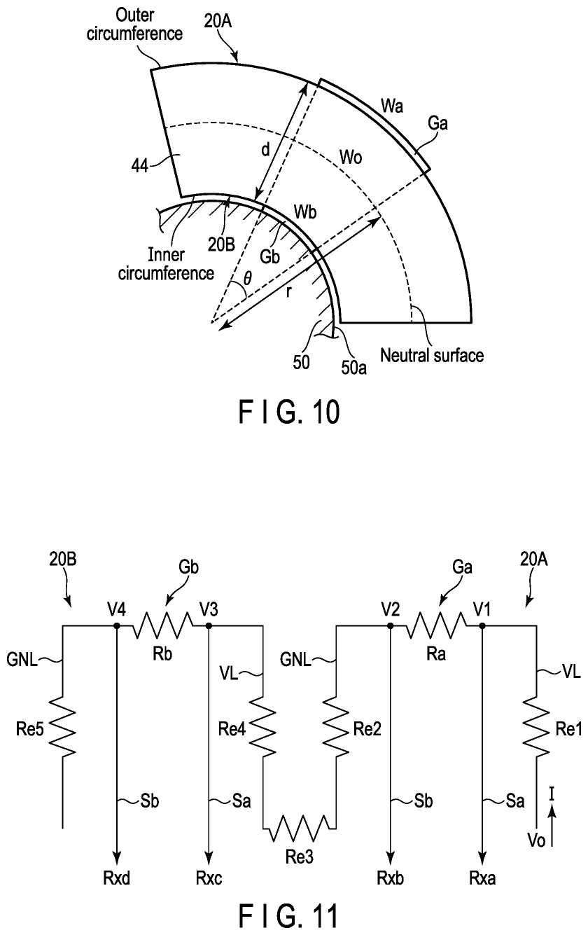

FIG. 10 is a view schematically showing a part of the strain gauge sensor device installed on the circumferential surface 50a of the above-mentioned subject 50. As shown in the drawing, in a state of being installed on the circumferential surface 50a, a neutral surface of the base substrate 44 is curved with the same radius of curvature r as the circumferential surface 50a. In this case, the neutral surface is a surface where neither elongation nor contraction occurs before and after the curvature of the strain gauge sensor (i.e., the strain is zero even after the curvature). In the embodiment, the neutral surface is provided at a position which is the center (thickness×½) of the base substrate 44 in the thickness direction.

The strain gauge Ga of the first sensor sheet 20A located on the outer circumferential side and the strain gauge Gb of the second sensor sheet 20B located on the inner circumferential side are opposed to each other in the radial direction and are curved at different radii of curvature.

In FIG. 10 and expressions shown below, W0: initial width of the strain gauge, Wa: strain gauge width on the outer circumferential side, Wb: strain gauge width on the inner circumferential side, ΔW: width of change of the strain gauge, d: base thickness, θ: opening angle of the strain gauge, r: radius of curvature of the neutral surface, k: gauge ratio, R0: strain gauge reference resistance, ΔR: strain gauge resistance change are shown.

When the width of the strain gauge G on the neutral surface of the base substrate 44 is the initial width W0 of the strain gauge, then W0=rθ. The strain gauge Ga on the outer circumferential side is deformed into an extended state by curving, and its gauge width Wa is as follows.

$${W}_{a} = ( r + \frac{d}{2} ) θ = {W}_{0} + Δ W$$

The strain gauge Gb on the inner circumferential side is deformed into a contracted state by curving, and its gauge width Wb is as follows.

$${W}_{b} = ( r - \frac{d}{2} ) θ = {W}_{0} - Δ W$$

The width of change ΔW is ΔW=dθ/2, and the radius of curvature r of the neutral surface (corresponding to the circumferential surface 50a of the subject) is as follows.

$$r = \frac{{W}_{0}}{θ} = \frac{d}{2} \frac{{W}_{0}}{Δ W} = \frac{kd}{2} \frac{{R}_{0}}{Δ R} … \qquad ( 1 )$$

FIG. 11 is a view schematically showing an equivalent circuit of the first sensor sheet 20A and the second sensor sheet 20B.

As shown in the drawing, the ground line GNL of the first sensor sheet 20A is connected to the power supply line VL of the second sensor sheet 20B, i.e., short-circuited, according to the embodiment. As a result, the strain gauge Ga on the outer circumferential side and the strain gauge Gb on the inner circumferential side are connected in series. At the strain detection, the voltage drop is measured at one end and the other end of each of the strain gauges Ga and Gb.

When the initial resistance of each of the strain gauges Ga and Gb before deformation is R0, the resistance of the strain gauge Ga on the outer circumferential side after deformation is Ra, the resistance of the strain gauge Gb on the inner circumferential side after deformation is Rb, the voltage values at one end and the other end of the strain gauge Ga on the outer circumferential side are V1 and V2, the voltage values at one end and the other end of the strain gauge Gb on the inner circumferential side are V3 and V4, the resistance change of the strain gauge is ΔR, and the current flowing through each of the strain gauges Ga and Gb is I, a voltage drop V12 between one end and the other end of the strain gauge Ga and a voltage drop V34 between one end and the other end of the strain gauge Gb are as follows.

$${V}_{12} = {V}_{1} - {V}_{2} = {R}_{a} I$$

$${V}_{34} = {V}_{3} - {V}_{4} = {R}_{b} I$$

When the above expression is divided by the following expression, the following relationship is obtained.

$$\frac{{V}_{12}}{{V}_{34}} = \frac{{R}_{a}}{{R}_{b}}$$

The following expression is obtained with the change in strain gauge resistance.

$$\frac{{V}_{12}}{{V}_{34}} = \frac{{R}_{0} - Δ R}{{R}_{0} + Δ R}$$

Based on the above expression, the change rate of the strain gauge resistance is calculated by the following expression.

$$( \frac{{V}_{12}}{{V}_{34}} - 1 ) {R}_{0} - ( \frac{{V}_{12}}{{V}_{34}} + 1 ) Δ R = 0$$

$$\frac{Δ R}{{R}_{0}} = \frac{{V}_{12} - {V}_{34}}{{V}_{12} + {V}_{34}}$$

The above relational expression is applied to the above-mentioned expression (1) for calculating the radius of curvature r, the following expression is obtained.

$$r = \frac{kd}{2} \frac{{R}_{0}}{Δ R} = \frac{kd}{2} \frac{( {V}_{12} + {V}_{34} )}{( {V}_{12} - {V}_{34} )} … \qquad ( 2 )$$

The strain gauge sensor device 10 detects the voltage values at one end and the other end of each of the strain gauges G1 to Gn, and can thereby calculate the radius of curvature r of the circumferential surface 50a of the subject 50 from the difference values (V12 and V34) and the above expression (2). By sequentially calculating the radii of curvature at a plurality of parts on the circumferential surface 50a, the strain gauge sensor device 10 can detect the curved form of the entire circumferential surface 50a.

Incidentally, according to the strain gauge sensor device 10, even if the wiring resistances (Re1 to Re5) of the wirings drawn on the sheet sensor or the relay substrate occur, only the resistance change of the strain gauges can be detected without being affected by these wiring resistances, by arranging the strain gauges on both front and rear surfaces so as to be opposed to each other and further detecting the curved form based on the difference value of the measured voltage.

According to the strain gauge sensor device 10 of the first embodiment configured as described above, the strain gauges G1 to Gn of the first sensor sheet and the strain gauges G1 to Gn of the second sensor sheet are arranged to be opposed to each other with the base sandwiched therebetween, and further, the strain gauges of the first sensor sheet and the strain gauges of the second sensor sheet are connected in series by short-circuiting the power supply line of the first sensor sheet and the ground line of the second sensor sheet. Therefore, the strain gauges G1 to Gn of the second sensor sheet can be sequentially driven (scanned) in synchronization with the sequential driving (scanning) of the strain gauges G1 to Gn of the first sensor sheet, and the strain can be detected at the same parts simultaneously by the two opposed strain gauges on the front and rear sides. Furthermore, at the detection, a constant current I can be passed through the two opposed strain gauges, and the curved form can be detected with high accuracy by taking the difference between the detection signals of the two strain gauges.

As described above, the strain gauge sensor device 10 can detect only the resistance change of the strain gauges G1 to Gn, and can improve the detection accuracy since elements other than the resistance change of the strain gauges (such as wiring resistance between the power supply and the strain gauges) are not mixed in the detected signals. In addition, by sequentially driving (scanning) a plurality of strain gauges G1 to Gn from one end side to the other end side of the strain gauge row, power consumption at the detection can be reduced as compared to a case of simultaneously driving all the plurality of strain gauges.

Based on the above, according to the embodiment, the strain detection device capable of improving the detection accuracy can be obtained.

Next, the strain gauge sensor device according to a modified example will be described. In the modified example described below, the same portions as those of the above-described embodiment are denoted by the same reference numerals, and the detailed descriptions may be simplified or omitted.

### (Modified Example)

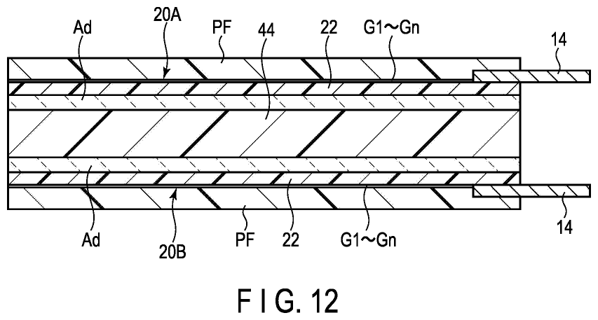

FIG. 12 is a cross-sectional view showing the first and second sensor sheets in the strain gauge sensor device according to a modified example. As shown in the drawing, according to the modified example, the sheet base 22 of the first sensor sheet 20A is attached to the front surface of the base substrate 44 by an adhesive layer Ad such as a transparent adhesive sheet (OCA). A protective film PF is stacked on the side of the conductor patterns (G1 to Gn) of the first sensor sheet 20A.

In the second sensor sheet 20B, the sheet base 22 is attached to the rear surface of the base substrate 44 by an adhesive layer Ad such as a transparent adhesive sheet (OCA). A protective film PF is stacked on the side of the conductor patterns (G1 to Gn) of the second sensor sheet 20B.

In the modified example, the other components of the strain gauge sensor device are the same as those of the strain gauge sensor device of the embodiment described above. The same advantages as those of the above-described embodiment can also be obtained in the strain gauge sensor device according to the modified example.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

All configurations that can be designed and modified by those skilled in the art based on the above-described configurations as embodiments of the invention also fall within the scope of the invention, insofar as they encompass the gist of the invention.

For example, the direction in which scanning the strain gauges is driven is not limited to the direction from the strain gauge G1 on the distal end side to the strain gauge Gn on the proximal end side, but may be the opposite direction from the strain gauge Gn on the proximal end side to the strain gauge G1 on the distal end side. The connection lines connecting the power supply lines and the ground lines are not limited to the plated through holes, but may be composed of wirings in the selector SEL, as shown in FIG. 8.

In addition, the number of rows of the strain gauges in the sensor sheets is not limited to the embodiment described above, but can be selected arbitrarily. The component material, dimensions, and shape of the sensor sheets are not limited to the above-described embodiments, but can be changed as needed.

What is claimed is:

1. A strain detection device comprising:
a flexible base having a first main surface and a second main surface opposed to the first main surface;
a first sensor sheet provided on a side of the first main surface;
a second sensor sheet provided on a side of the second main surface and opposed to the first sensor sheet with the base sandwiched therebetween; and
a controller configured to drive the first sensor sheet and the second sensor sheet, wherein
each of the first sensor sheet and the second sensor sheet comprises:
a plurality of strain gauges including first ends and second ends located on a side opposite to the first ends and arranged in a row at intervals; and
a plurality of power supply lines, a plurality of ground lines, a plurality of first signal lines, and a plurality of second signal lines, which include portions extending along the row of the plurality of strain gauges,
each of the plurality of power supply lines is connected to corresponding one of the first ends of the plurality of strain gauges,
each of the plurality of first signal lines is connected to corresponding one of the first ends of the plurality of strain gauges,
each of the plurality of ground lines is connected to corresponding one of the second ends of the plurality of strain gauges,
each of the plurality of second signal lines is connected to corresponding one of the second ends of the plurality of strain gauges,
each of the plurality of strain gauges of the first sensor sheet is arranged to be opposed to corresponding one of the plurality of strain gauges of the second sensor sheet with the base sandwiched therebetween, and
each of the plurality of ground lines of the first sensor sheet is connected to corresponding one of the plurality of power supply lines of the second sensor sheet.

2. The strain detection device of claim 1, wherein
the controller comprises a selector sequentially applying power supply voltages to the plurality of power supply lines of the first sensor sheet, sequentially driving a plurality of strain gauges of the first sensor sheet and a plurality of strain gauges of the second sensor sheet so as to be synchronized with each other, and sequentially acquiring detection signals of the first ends and detection signals of the second ends, of the strain gauges, from the first signal lines and the second signal lines.

3. The strain detection device of claim 1, wherein
the controller includes a first difference detection circuit which detects a difference between detection signals of the first ends and detection signals of the seconds, of the strain gauges of the first sensor sheet, and a second difference detection circuit which detects a difference between detection signals of the first ends and detection signals of the seconds, of the strain gauges of the second sensor sheet.

4. The strain detection device of claim 2, wherein
the controller sequentially drives the plurality of strain gauges from a one-end side to the other end side of the row of the plurality of strain gauges.

5. The strain detection device of claim 1, wherein
the controller includes a circuit board connected to lines of the first sensor sheet and lines of the second sensor sheet, and the circuit board includes connection lines connecting the ground lines of the first sensor sheet with the power supply lines of the second sensor sheet.

6. The strain detection device of claim 2, wherein
the controller includes a circuit board connected to lines of the first sensor sheet and lines of the second sensor sheet, and the selector is provided on the circuit board and includes wirings connecting the ground lines of the first sensor sheet with the power supply lines of the second sensor sheet.

7. A strain detection device comprising:
a base having a first main surface and a second main surface opposed to the first main surface;
a first sensor sheet provided on a side of the first main surface; and
a second sensor sheet provided on a side of the second main surface, wherein
the first sensor sheet comprises:
a plurality of first strain gauges each including a first end and a second end located on a side opposite to the first end and arranged in a row; and
a plurality of first power supply lines, a plurality of first ground lines, a plurality of first signal lines, and a plurality of second signal lines,
each of the plurality of first power supply lines is connected to corresponding one of the first ends of the plurality of first strain gauges,
each of the plurality of first signal lines is connected to corresponding one of the first ends of the plurality of first strain gauges,
each of the plurality of first ground lines is connected to corresponding one of the second ends of the plurality of first strain gauges,
each of the plurality of second signal lines is connected to corresponding one of the second ends of the plurality of first strain gauges,
the second sensor sheet comprises a plurality of second strain gauges arranged in a row and a plurality of second power supply lines,
each of the plurality of second strain gauges is connected to corresponding one of the second power supply lines, and
each of the plurality of first ground lines is connected to corresponding one of the plurality of second power supply lines.

8. The strain detection device of claim 7, wherein
the plurality of first power supply lines, the plurality of first ground lines, the plurality of first signal lines, and the plurality of second signal lines include portions extending along the row of the plurality of first strain gauges.

9. The strain detection device of claim 7, wherein
each of the plurality of first strain gauges is opposed to corresponding one of the plurality of second strain gauges.

10. The strain detection device of claim 7, which further comprises a controller, wherein
the controller sequentially applies power supply voltages to the plurality of first power supply lines, synchronizes each of the plurality of first strain gauges with corresponding one of the plurality of corresponding second strain gauges, and sequentially drives the plurality of first strain gauges and the plurality of second strain gauges.

11. The strain detection device of claim 10, wherein
the controller comprises a selector sequentially acquiring a plurality of detection signals detected by the plurality of first strain gauges, and
each of the plurality of first strain gauges detects a first detection signal supplied to the selector via corresponding one of the plurality of first signal lines and a second detection signal supplied to the selector via corresponding one of the plurality of second signal lines.

12. The strain detection device of claim 11, which further comprises a circuit board, wherein
the circuit board includes a plurality of wirings connecting the plurality of first ground lines with the plurality of second power supply lines, and the selector is located on the circuit board.

13. The strain detection device of claim 7, wherein
each of the plurality of first strain gauges includes a difference detection circuit which detects a first detection signal output to corresponding one of the plurality of first signal lines and a second detection signal output to corresponding one of the plurality of second signal lines, and which detects a difference between the first detection signal and the second detection signal.

14. The strain detection device of claim 7, which further comprises a circuit board, wherein
the circuit board includes a plurality of wirings connecting the plurality of first ground lines with the plurality of second power supply lines.
